(19) United States
(12) Patent Application Publication
(10) Pub. No.: US 2005/0038990 A1
(43) Pub. Date: Feb. 17, 2005

(54) Authorization device, method and program

(75) Inventors: Akihiro Sasakura, Kawasaki (JP); Isao Funaki, Yokohama (JP); Yukihiro Noda, Yokohama (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/780,573

(22) Filed: Feb. 19, 2004

(30) Foreign Application Priority Data
Jul. 23, 2003 (JP) 2003-200745

(51) Int. Cl. H04L 9/00

(52) U.S. Cl. 713/155

(57) ABSTRACT

Unique data which can identify functions of a client or individual is assigned to the client and thus a server can determine based on this unique data whether the services can be provided or not. Moreover, unique user data is also added for authorization of the user to use the services.

This application claims the benefit of priority to Japanese patent application number 2003-200745, filed Jul. 23, 2003, in the Japanese Patent Office, the disclosure of which is incorporated herein by reference.

### BACKGROUND OF THE INVENTION

1. Field of the Invention

The present invention relates to an authorization device for authorizing a server to provide various services to clients and more particularly to authorization of clients.

2. Description of the Related Art

The service programs executed by a server provide various services to users who can operate clients through communication networks such as the Internet. Practically, various services include electronic mail, purchasing of products, and distribution of images and voices. For implementation of these services, it is essentially required to authorize users in order to prevent substitution and falsification of users and to identify the registered users.

The use of anID and password of a user in authorization technosogy is known in the art, as described in Japanese Published Unexamined Patent Application (kokai) No. 9-81519 corresponding to U.S. Pat. No. 5,706,427.

However, a certain kind of services cannot be provided, although a user can be identified through the authorization, because functions of client are insufficient. For example, the client is always required to provide audio input/output and video input/output facilities in order to provide services such as TV phone and TV conference to users. When such services are requested, the server requests confirmation that the relevant client is provided with sufficient functions for the services to the client or makes direct inquiry to users. Otherwise, these services are requested without any confirmation and sufficient services would not be provided to users.

Moreover, the conventional authorization technology has requested input of a password to authorize users. Particularly, in recent years, users are often forced to set the password which is longer than a minimum length in order to assure security. When the password becomes longer, users will more likely forget their passwords. Moreover, it has been very troublesome for users to input a longer password whenever they want to enjoy various services.

### SUMMARY OF THE INVENTION

In view of achieving the aspects described above, the present invention includes an authorization device comprising a computer information storage section to store the information of a computer including unique data which identifies the computer, a unique data receiving section to receive, from the computer, the unique data of the computer, and a computer searching section to search, from the computer information storage section, the information of the computer corresponding to the received unique data.

Moreover, the present invention may also be provided with a communication determining section to determine whether particular communication with the computer is possible or not with the information of computer.

According to another aspect, the present invention includes an authorization device comprising an unique data receiving section to receive, from the computer, the unique data which identifies the computer, a user information storage section to store unique user data indicating a user who can use the computer corresponding to the unique data, and an authorizing section to authorize the user on the basis of the unique data received by the unique data receiving section and the user information storage section.

According to the other aspect, the present invention includes a computer comprising an unique data storage section to store an unique data which identifies the computers, an external referenced storage region which can be referenced from external computers, a unique data copying section to copy the unique data stored in the unique data storage section to the external referenced storage region, and a unique data transmitting section to transmit the unique data stored in the external referenced storage region to external computers.

According to still other aspect, the present invention includes a communication system to communicate between servers and clients, in which a client comprises an unique data storage section to store an unique data which identifies the client and a unique data transmitting section to transmit the unique data to servers, and a server comprises a client information storage section to store information of clients for each unique data, a unique data receiving section to receive the unique data, and a client searching section to search information of clients of the received unique data.

According to the present invention, the authorization device is capable of obtaining information of computers, for example, the information of types and functions of the computers from the received unique data of each computer and this information can be used for authorization.

Moreover, the authorization device of the present invention is capable of determining whether communication with the computers, which requires the particular functions such as TV phone and TV conference, can be accomplished with the computers based on the information of computer.

According to another aspect of the other present invention, the authorization device is capable of realizing authorization without input for authorization of individuals when a user makes communication using the particular computer, by storing, to the user information storage section, that a user makes communication using the particular computer.

According to another aspect of the other present invention, the computer can easily obtain unique data without use of the particular program with the other computers by copying the unique data stored in the unique data storage section to the region which may be used easily for the communication with the external computers.

According to the other present invention, the system is capable of obtaining information of computer, for example, the information of types and functions of computers from unique data of clients and the obtained information can be used for authorization of communication.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a structural diagram of the present invention.

FIG. 2 is a structural diagram of a personal computer in the present invention.

FIG. 3 is a structural diagram of a computer information recording table in the present invention.

FIG. 4 is a structural diagram of a user information recording table in the present invention.

FIG. 5 is a flowchart for user registration in the present invention.

FIG. 6 is a structural diagram of read operation of PCID and write operation thereof to Cookie in the present invention.

FIG. 7 is a flowchart of user authorization in the present invention.

### DETAILED DESCRIPTION OF THE PREFERRED EMBODIMENTS

An embodiment of the present invention will be described hereunder in detail with reference to the accompanying drawings. In this embodiment, by way of a nonlimiting example, the TV phone service is provided using a personal computer of a user.

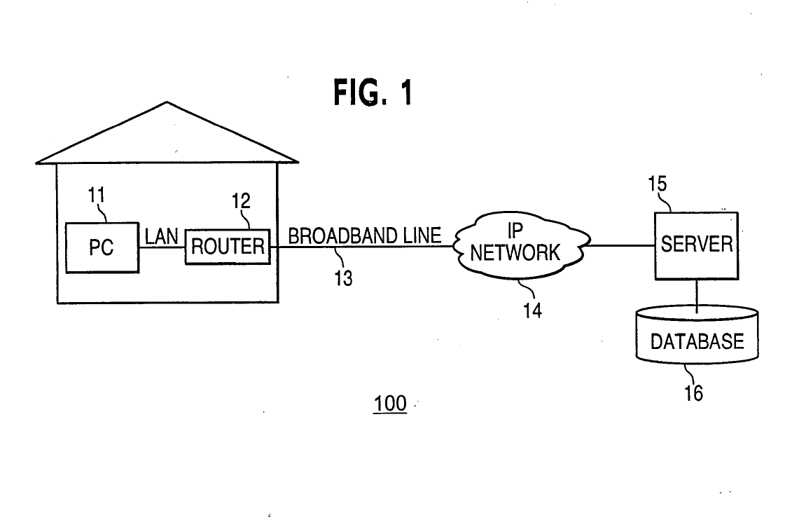

FIG. 1 illustrates a structure of an authorization system 100 of this embodiment.

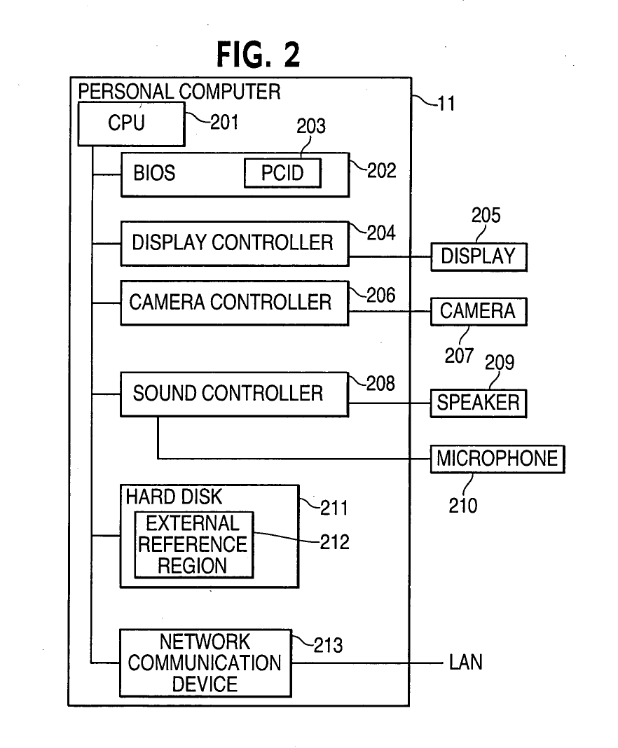

As shown in FIG. 1, personal computer 11 of a user has the functions required to implement the TV phone service. In order to provide the TV phone service, the personal computer 11 comprises a display screen for regenerating the received moving picture, a camera for taking photos of the moving picture to be transmitted, a speaker for regenerating the received voice signal, and a microphone for collecting voices to be transmitted. The personal computer 11 is described in further detail with reference of FIG. 2.

Referring again to FIG. 1, a router 12 is used as the device for communication between the personal computer 11 and external computers. In this embodiment, the router 12 is connected to the personal computer via a local area network (LAN).

A broad band line 13 connects between the router 12 and an IP (Internet Protocol) communication network 14 formed in the profile of ADSL, private line, cable television or optical fiber or the like.

The IP communication network 14 realizes communication between the router 12 and a server 15. The IP communication network 14 may be a large size communication network like the Internet or may be a closed communication network only for the particular users.

The server 15 can provide various services to users and ensures security of communication through authorization for providing services.

A database 16 records data for authorization.

FIG. 2 illustrates a block diagram of the personal computer 11.

A CPU (Central Processing Unit) 201 controls the personal computer 11.

BIOS (Basic Input/Output System) 202 is a program for basic input and output for the personal computer 11. The CPU 201 reads and executes the program of the BIOS 202. The BIOS 202 is stored in a non-volatile memory such as flash memory and in a ROM which disables erasing and reprogramming operations.

A PCID 203 is an identifier for determining the personal computer 11 and is stored within the BIOS 202. The PCID 203 is considered to be stored in the format of the serial number, model name or type of the personal computer 11. The PCID 203 is stored within the ROM which disables a reprogramming operation but it may be stored in the reprogrammable storage region with use of the falsification-preventing technology. In this embodiment, the PCID 203 is stored in the non-reprogrammable ROM with recording of the serial number of the personal computer 11.

A display controller 204 displays a received moving picture on a display 205.

A camera controller 206 records the picked-up images to a camera 207.

A sound controller 208 regenerates the received voices with a speaker 209 and records voice signals with a microphone 210.

A hard disk 211 stores programs and data in the personal computer 11. The programs include the operating system (OS), and Web browser or the like.

The external reference storage region 212 can be easily referenced by external computers among the storage regions of the hard disk 211.

For example, a Cookie function of the Web browser enables the Web server to control the Web client to store the data such as reference record of the Web server as the Cookie data. The Web server can obtain the information in the Cookie without use of particular program only with access to the Web server from the Web browser corresponding to the Cookie.

A network communication device 213 can realize communication with external computer and router. In this embodiment, communication with the router 12 can be realized using the LAN.

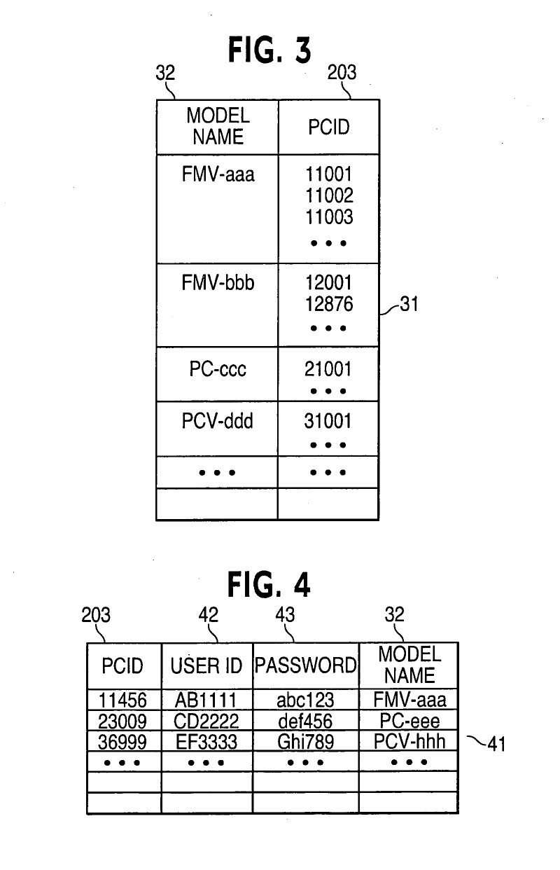

FIG. 3 illustrates a structural format of a computer information recording table 31 stored in the database 16.

The computer information recording table 31 previously records information of the personal computer 11.

The PCID 203 is recorded as the serial number of the computer11 in this embodiment.

A model name 32 is the model name of the personal computer 11. The server 15 can identify the model name 32 of the personal computer 11 from the PCID 203 of the personal computer 11 and can determine whether the TV phone service can be provided or not from the model name 32.

FIG. 4 illustrates a structural format of a user information recording table 41 stored in the database 16.

The user information recording table 41 is updated when a user of the TV phone service has conducted registration procedures to the server 15 in order to receive the relevant service. At the time of registration, the server 15 registers a user ID 42 for identifying the user and an authorization password 43 of the same user together with the PCID 203 of the personal computer 11 used by the relevant user and the model name 32 of the same personal computer. Through the use of only one personal computer 11, a plurality of users may utilize the TV phone service. Moreover, a user may utilize the TV phone service using a plurality of personal computers 11.

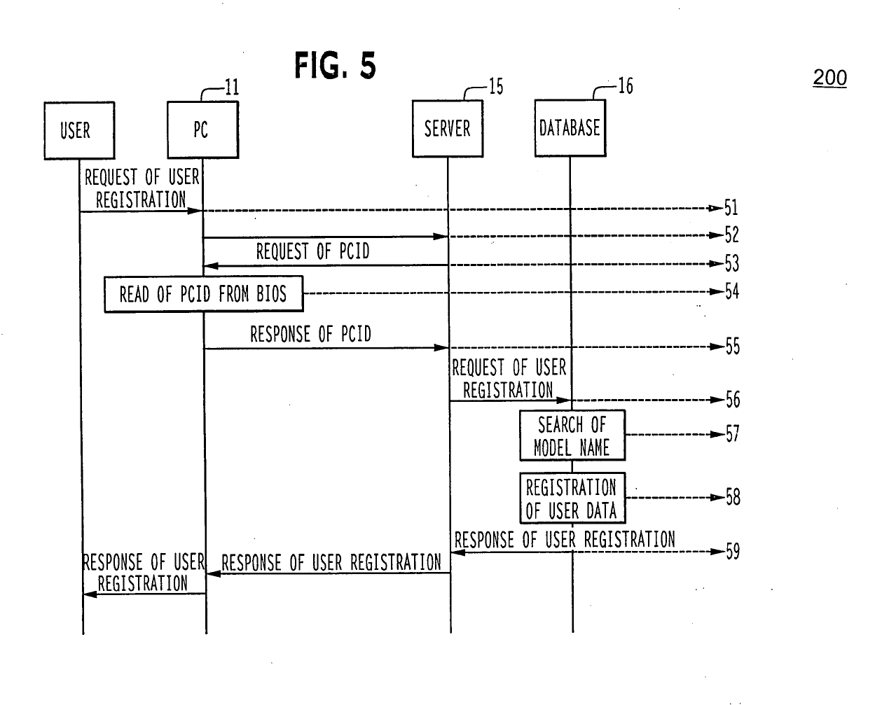

FIG. 5 illustrates a flowchart 200 for registration of users to the server 15.

A user refers to the homepage of the server 15 using the personal computer 11 in order to newly register the application of TV phone service. A user inputs on the homepage own user ID 42 and password 43 and performs manipulation for determination (operation 51).

When manipulation for determination is conducted, the user ID 42 and password 43 inputted are then transmitted to the server 15 (operation 52).

Next, the server 15 determines whether the personal computer 11 can provide the normal TV phone service or not.

The server 15 requests the PCID 203 to the personal computer 11 (operation 53).

The personal computer 11 receives an instruction from the server 15 in the operation 53 and reads the PCID 203 of the BIOS 202 (operation 54).

The PCID 203 obtained is transmitted to the server 15 (operation 55).

When the PCID 203 of the personal computer 11 can be obtained, the server 15 determines to register the PCID 203 to the database 16 together with the user ID 42 and password 43 of the user (operation 56). If the personal computer 11 is of the model having no PCID 203, the server 15 cannot obtain the PCID 203, and it registers only the user ID 42 and password 43 of the user.

The database 16 searches the model name using the computer information recording table 31 and PCID 203 (operation 57). Here, the database 16 can determine whether the personal computer 11 can realize the TV phone service or not. Moreover, the server 15 can also make such a determination. If the personal computer 11 cannot provide the TV phone service, the database 16 suspends the registration work and notifies the server 15 that realization of the TV phone service is impossible. The server 15 notifies a user that the relevant personal computer 11 cannot realize the TV phone service. In this case, it is also considered whether to recommend use of a personal computer 11 which can realize the TV phone service whether to and recommend the peripheral devices to be added to the personal computer 11 to realize the TV phone service.

When the personal computer 11 can provide the TV phone service, the user is registered (operation 58). The user ID 42 and password 43 are registered to the user information recording table 41 together with the PCID 203.

Upon completion of registration, the database 16 transmits, to the user, notice of completion of registration through the server 15 and personal computer 11 (operation 59). The user is now capable of utilizing the TV phone service through the personal computer 11.

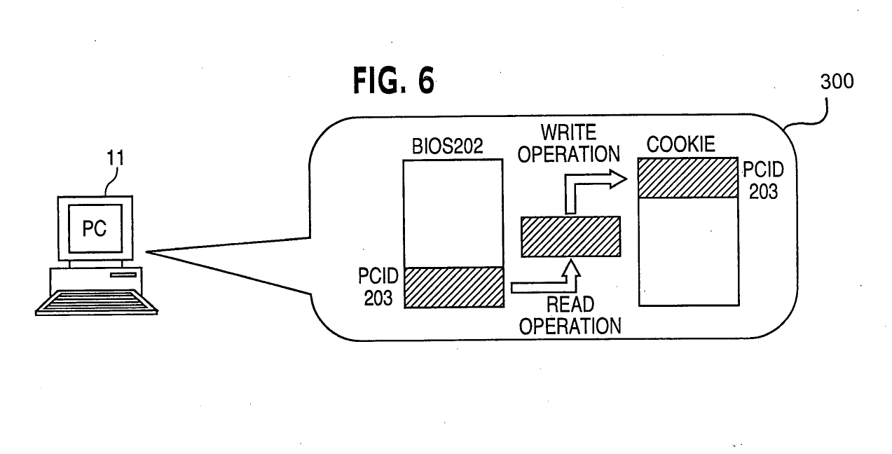

FIG. 6 illustrates example 300 of a read operation of the PCID 203 and write operation thereof to the Cookie.

For the read operation of the PCID 203 in operation 54, it is required for the personal computer 11 to previously install the program for the read operation. For the transmission of the PCID 203 to the server 15, a communication program is usually required. However, in the present invention, the PCID 203 is written as the Cookie, in relation to the homepage of the server 15 as illustrated in FIG. 6, to the external reference storage region to be referenced from external computers, for example, to the storing area of the Cookie used by the Web browser. When the PCID 203 is written as the Cookie, the server 15 can access the PCID 203 without addition of the communication program to the personal computer 11 only by accessing to the homepage of the server 15 with the Web browser from the personal computer 11.

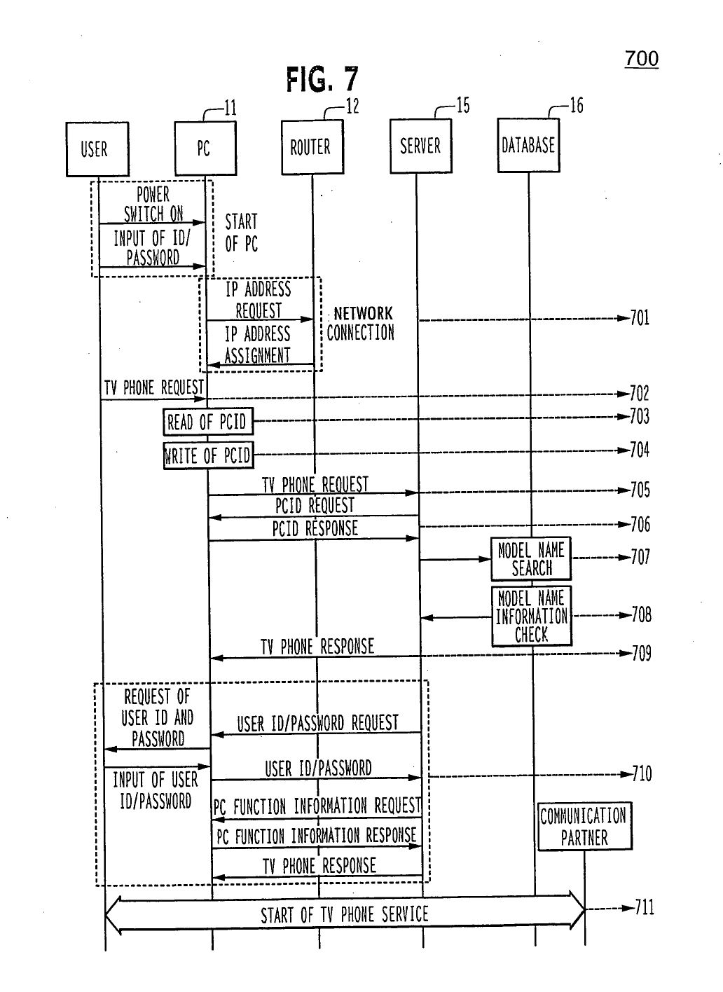

FIG. 7 illustrates a flowchart 700 for authorization of user.

When the router 12 assigns an IP address responding to the request for the IP address from the personal computer 11, the personal computer 11 is connected to the IP network 14 (operation 701).

A user requests, using the Web browser, the TV phone service to the personal computer 11 through the homepage of the server 15 (operation 702).

The personal computer 11 reads the PCID 203 from the BIOS 202 and writes the PCID 203 to the Cookie (operations 703, 704).

On the basis of the request from the user, the personal computer 11 sends a request for the TV phone service to the server 15 (operation 705).

The server 15 gets the PCID 203 in the Cookie from the personal computer 11, based on the request of operation 705 from the personal computer 11 (operation 706).

The server 15 transmits the PCID 203 to the database 16, while the database 16 searches whether the PCID 203 is already registered or not in the user information recording table 41 of the database 16 on the basis of the PCID 203 obtained in the operation 706 (operation 707).

When it is proved as a result of search operation that the PCID 203 is already registered, the server 15 can obtain the user ID 42 and password 43 from the user information recording table 41 based on the PCID 203 and thereby the user can be authorized (operation 708).

If any problem does not exist in the authorization process of the operation 708, the server 15 sends a response to the personal computer 11 for the request of the TV phone service in the operation 705 (operation 709) and starts the TV phone service (operation 711).

If the PCID 203 is not yet registered, the server 15 instructs the personal computer 11 to input the user ID 42 and password 43 of the user (operation 710). When the personal computer 11 has the PCID 203, the user of the user information recording table 41 can newly register such PCID 203 in this operation.

Moreover, a plurality of users are requesting to receive the TV phone service using the personal computer 11, each user can be identified by transmitting the user ID 42 together with the PCID 203 in the operations 705 and 707. In the present invention, moreover, a user can be authorized without use of the password, because if another user illegally uses the user ID 42, this user cannot act as the user having the user ID 42, so long as this illegal user does not communicate using the personal computer 11 having the PCID 203.

In this embodiment, the TV phone service using the personal computer has been described, but the present invention can be applied to other services, and the computer apparatuses other than personal computer can also be used.

The system also includes permanent or removable storage, such as magnetic and optical discs, RAM, ROM, etc. on which the process and data structures of the present invention can be stored and distributed. The processes can also be distributed via, for example, downloading over a network such as the Internet.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

1. An authorization device comprising:
a computer information storage section to store information of computers for each computers including unique data which uniquely identify each of the computers;
an unique data receiving section to receive, from said computers, said unique data of the computers; and
a computer searching section to search said information of computer corresponding to said received unique data from said computer information storage section.

2. The authorization device according to claims 1, further comprising:
a communication determining section to determine whether particular communication with said computers is possible or not depending on said information of the computers.

3. An authorization device comprising:
an unique data receiving section to receive, from computers, unique data which uniquely identify said computers;
a user information storage section to store unique user data indicating a user who can use one of said computers corresponding to said each unique data; and
an authorizing section to authorize the user on the basis of said unique data received by said unique data receiving section and said unique user data stored in said user information storage section.

4. A computer comprising:
a unique data storage section to store unique data identifiable computers;
an external reference storage region which can be referenced by external computers;
a unique data copying section to copy said unique data stored in said unique data storage section to said external reference storage region; and
a unique data transmitting section to transmit said unique data stored in said external reference storage region to the external computers.

5. A communication system communicating between a server and clients, comprising:
a unique data storage section included in at least one of said clients to store unique data which uniquely identify the clients;
a unique data transmitting section included in at least one of said clients to transmit said unique data to the server;
a client information storage section included in said server to store information of said client for said each unique data;
a unique data receiving section included in said server to receive said unique data; and
a client searching section included in said server to search information of said client corresponding to said received unique data on the basis of said client information storage section for authorizing communication between the server and the clients based on said information of the clients.

6. A computer-readable medium storing a program which, when executed by a computer, causes the computer to perform operations comprising:
receiving, from an external computer, unique data which uniquely identify said external computer; and
searching information of said external computer corresponding to said received unique data from a computer information storage section to store information of the external computer for each unique data.

7. A computer-readable medium according to claim 6, further comprising:
determining whether communication with said external computer is possible or not depending on said information of said external computer.

8. A computer-readable medium storing a program which, when executed by a computer, causes the computer to perform operations comprising:
receiving, from an external computer, unique data which uniquely identify said external computer; and
authorizing a user on the basis of said received unique data and unique user data, stored in a user information storage section, data indicating the user who can use said external computer corresponding to each unique data for each unique data.

9. A computer-readable medium storing a program which, when executed by a computer, causes the computer to perform operations comprising:
reading unique data which uniquely identify computers from a unique data storage section storing said unique data; and
copying said unique data to an external reference storage region which can be referenced from external computers.

10. An authorization device, comprising:
a unique data receiving section to receive, from a computer, unique data which uniquely identify said computer; and
an authorizing section to authorize said computer on the basis of said received unique data.

11. An authorization method comprising:
receiving, from an external computer, unique data which identify said external computer; and
searching information of said external computer corresponding to said received unique data from a computer information storage section to store information of the external computer for each unique data.

12. The authorization device according to claim 2, wherein said information of computer are information of model of said computer for identifying function of said computer.

13. The computer according to claim 4, wherein said external reference storage region is an area storing cookie information.
